(19) United States
(12) Patent Application Publication
(10) Pub. No.: US 2007/0143842 A1
(43) Pub. Date: Jun. 21, 2007

(54) Method and system for acquisition and centralized storage of event logs from disparate systems

(76) Inventors: Alan K. Turner, West Tawakoni, TX (US); Chris E. Bullok, Campbell, TX (US); Kent L. Irvin, Nevada, TX (US); John C. Hayre, Greenville, TX (US); Kevin D. Markham, Greenville, TX (US)

Correspondence Address: O'KEEFE, EGAN, PETERMAN & ENDERS LLP, 1101 CAPITAL OF TEXAS HIGHWAY SOUTH, #C200, AUSTIN, TX, 78746, US

(21) Appl. No.: 11/300,737

(22) Filed: Dec. 15, 2005

(51) Int. Cl. G06F 12/14

(52) U.S. Cl. 726/22

(57) ABSTRACT

A method and system are disclosed for acquisition and centralized storage of event logs from multiple systems. The present invention greatly improves the efficiency of event log review and analysis and is particularly useful for secure facilities performing periodic (e.g., weekly) event log audits for detection of security breaches. The present invention reduces human error by creating a centralized event log that automatically correlates event logs from disparate systems. The invention uses processing algorithms to analyze the centralized event log in order to identify events that meet selected criteria. A common format is utilized for the centralized event log to provide a uniform centralized event log that is easy to interpret by manual or automated analysis of the event data thereby greatly simplifying the audit process. In addition, the centralized event log can also be monitored on real time basis to detect sets of events triggering security alerts.

### TECHNICAL FIELD OF THE INVENTION

The present invention relates to analysis and review of system event logs that track system usage activities and, more particularly, to detection of potential security anomalies based upon the review of such event logs.

### BACKGROUND

Many systems have the capability of recording event logs associated with activity occurring on the system. In some environments, such as secure facilities, event logs are required to be audited in order to determine if potential security breaches have occurred. Traditionally, analyses of event logs for detection of security breaches has been conducted manually by one or more persons responsible for audit data interpretation. For example, secure computer facilities may have an information system security officer (ISSO) who has the responsibility of performing security audits of secure computer facilities including audits of system event logs.

The nature of an event log is typically dependent upon the type of system in operation. For example, with respect to personal computers running the WINDOWS operating system, event logs can be created using tools available with WINDOWS. Other types of systems may have event log tools as well. However, different systems do not track events uniformly. Thus, event logs within a heterogeneous secure computer laboratory may include large amounts of data stored in individual systems that is extremely diverse in content and form. For example, event logs for different systems may have very different schedules, may record very different data, and may use very different data formats. In general, event or user information logs store information such as login attempts, keyboard activity, network accesses, or other desired user activity. However, each different type of system will typically store event or user information logs in different formats with different types of data.

Because of these disparate event logs across disparate systems, required audits of event logs for secured computer facilities are extremely difficult tasks to complete. An ISSO or other responsible person cannot reasonably complete such a task in an effective manner due to the volume of manual review and analysis required in going to each system to check event logs. In addition, human error is a factor in this traditional manual technique because of the large amount of data involved and because of the problem in determining which events indicate possible security breaches.

### SUMMARY OF THE INVENTION

The present invention provides a method and system for acquisition and centralized storage of event logs from multiple disparate systems. The present invention allows for centralized review and analysis of event of user log information. Event logs from disparate computer and electronic systems are accessed, organized, formatted and stored in the centralized log such that events or selected events are correlated into a format of the centralized log in order to provide a uniform centralized event log. This centralized event log of the present invention greatly improves the efficiency of event log review across multiple systems and is particularly useful for security audits of user or event information logs.

In one embodiment, the present invention is a method for analyzing event logs from a plurality of different systems, including accessing an event log from each of a plurality of different systems where the event logs are configured to store data in two or more different formats, storing selected event data from each event log in a common format within a centralized event log within a centralized database, and analyzing the stored event data within the centralized database to identify events meeting one or more predetermined parameters. In addition, the storing step can include storing the selected event data from the different event logs in a chronological format. The centralized event log can be a security event log, and the parameters are selected can be based on security needs. Still further, the method can include monitoring the centralized event log on real time basis to detect events triggering security alerts. As described below, other features and variations can be implemented, if desired, and related systems can be utilized, as well.

In another embodiment, the present invention is a centralized log manager system for analyzing event logs from a plurality of different systems, including a plurality of different systems configured to store usage information in an event log where the event logs being configured to store data in two or more different formats, and a server system configured to communicate with the plurality of different systems to obtain event data from the event logs, to store selected event data from each event log in a common format in a centralized event log within a centralized database, and to analyze the stored event data within the centralized database to identify events meeting one or more predetermined parameters. In addition, the selected event data from the different event logs can be stored in a chronological format. The centralized event log can also be a security event log and the parameters are selected based on security needs. And the server system can be configured to monitor the centralized event log on real time basis to detect events triggering security alerts. As described below, other features and variations can be implemented, if desired, and related methods can be utilized, as well.

### DESCRIPTION OF THE DRAWINGS

It is noted that the appended drawings illustrate only exemplary embodiments of the invention and are, therefore, not to be considered limiting of its scope, for the invention may admit to other equally effective embodiments.

FIG. 1 is a system block diagram showing an example embodiment for a centralized audit log management (CALM) system according to the present invention.

FIG. 2 is an example flowchart describing the acquisition of event log data from a plurality of systems according to the present invention.

FIG. 3 is an example flowchart describing the analysis of event log data within a centralized event log database according to the present invention.

FIG. 4 is a block diagram of an example data processing system including a central processing unit for the acquisition and centralized storage of event logs from multiple systems according to the present invention.

### DETAILED DESCRIPTION OF THE INVENTION

The present invention provides a centralized audit log manager and related method for acquisition and centralized storage of event logs from multiple disparate systems. The method and system of the present invention greatly improves the efficiency of event log review and analysis and reduces human error by creating a centralized event log that automatically correlates event logs from disparate systems. The invention allows the use of a wide variety of processing algorithms to analyze the centralized event log in order to identify events that meet selected criteria. In addition, a common format can be utilized for the centralized event log to provide a uniform centralized event log that is easy to interpret by manual or automated analysis of the event data thereby greatly simplifying the audit process. In addition, the centralized event log can also be monitored on real time basis to detect sets of events triggering security alerts.

As described herein, the central audit log manager system of the present invention can be configured to automatically poll all of the system nodes of a network on a periodic basis to download system usage information stored in event logs on those systems. Alternatively, an audit manager or ISSO can trigger the system to poll all system nodes. The central audit log manager system then merges the collected data in a central database according to a desired data format and selected data fields. In this way, system usage information from disparate system can be combined into a single database in a meaningful manner. The central audit log manager system also provides the user various modes of filtering and/or sorting the data for purposes of analyzing the event information, and report building tools are also provided for generating reports for review and analysis.

In part, therefore, the present invention provides for the acquisition and centralized storage of heterogeneous event logs into a common format so that a user can more easily review event logs across numerous disparate systems and so that automated algorithms can be run on the data to identify security issues. Thus, the present invention thereby allows for more efficient security management and review. Example operational features of the centralized audit log manager (CALM) of the present invention includes gathering of event log data preferably in an automated manner, conversion of the event log data from disparate systems into a common data format within a single database, and analysis of the resulting combined database.

To gather the event log data, wired and/or wireless networks can be utilized so that a central server can access systems to obtain event log data from them in an automated and periodic fashion. If desired, CALM software modules can be operated on each system along with a central CALM software module on a secure server. These software modules, for example, can allow secure access and retrieval of event log data from systems that are being monitored. In addition, as discussed more below, systems can be any desired set of systems, including test equipment, computer systems, etc. for which system usage is desired to be monitored. It is also noted that the type of data being collected by individual systems will be dependent upon those systems and software tools available or developed for those systems. System usage information collected can include information such as key strokes, password log-in attempts, password log-out attempts, application usage, file access, file copy activities, file downloads, network accesses, or any other desired system usage parameter.

When the centralized servers has retrieved an event log from a system, the centralized server then converts the data for storage in the centralized event log database. As part of this process, a determination is made what data within each event log will be stored and how it will be stored. For example, only password log-in and password log-out activities could be recorded in chronological order. In addition, the data can be organized by individual system, or if desired, the data could be combined chronologically for all systems together. Alternatively, a wide variety of event data can be stored in a relational database, and then report tools can be utilized to filter, sort and display information within the database so that the user can see desired aspects of the data. In short, depending upon the goals of the user in reviewing event log data, any desired organizational structure and data selection could be implemented, as desired. In this way, sense can be made of event logs from different systems that may store different types of data in many different data formats.

Data analysis can then follow the conversion of the event log data into a centralized database. Now that the data from disparate systems is combined in a central point in a meaningful manner, a user can perform any desired manual or automated processing to identify events and behavior from usage data that evidences activities the user is trying to find. For example, the data can be searched for possible security breaches or violations. Unusual usage events can be investigated. Thus, by having the data in a combined database, a wide variety of automated and/or manual analyses can be implemented thereby keeping the user or ISSO from having to look individually at the event logs located locally at each different machine. In addition, the user or ISSO can review events occurring across multiple systems rather than being forced to focus on events occurring only at a single system.

As one example, the event log data from disparate systems can be organized into a single database of time-ordered events, including common data such as log-in and log-out activities. With data in this format, for example, analyses could be conducted for log-in attempts at odd times, multiple log-in failures during short periods of time, log-in failures across numerous systems, program access on multiple systems in short periods of time, file copy activities on one or more systems, etc. In short, processing algorithms can be developed and implemented to analyze the data so as to look for any desired activity or usage patterns. In addition, graphical display of the outcome of these analyses can also be generated to provide a user a quick way to analyze activity summaries. Thus, by providing a centralized event log database, the present invention provides a significantly improved mechanism and tool for reviewing and auditing usage activities occurring on disparate computing systems.

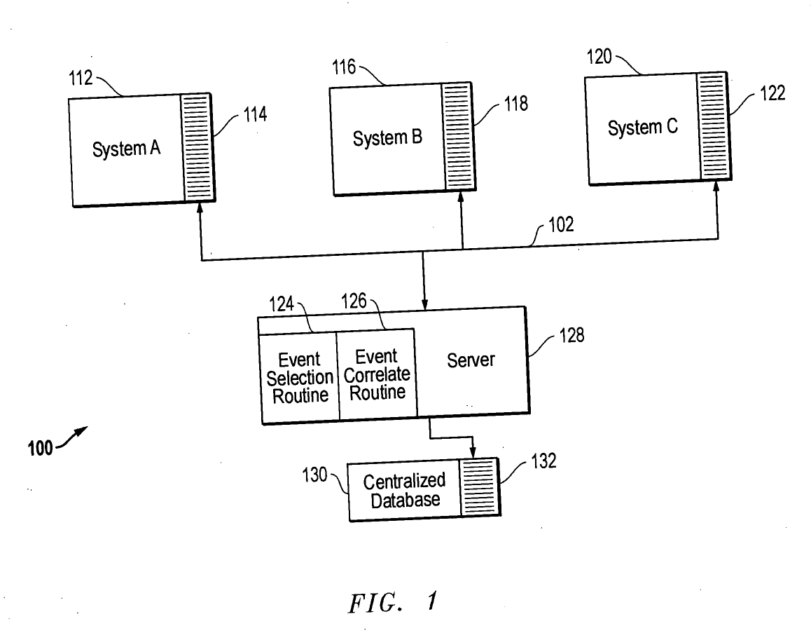

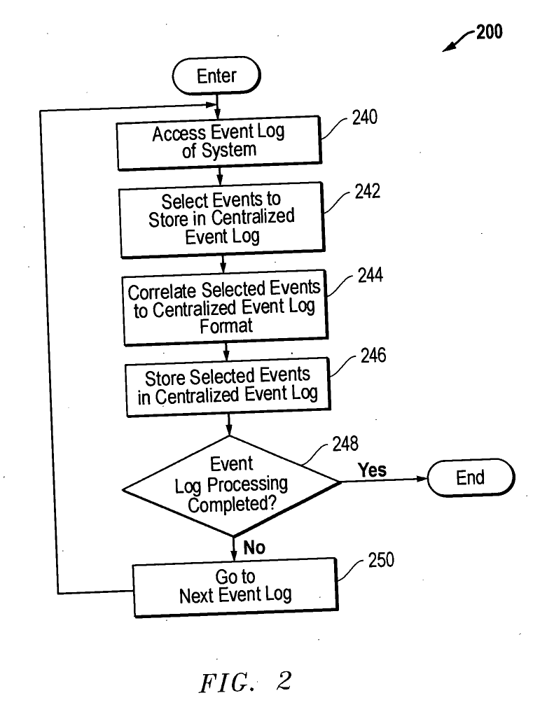

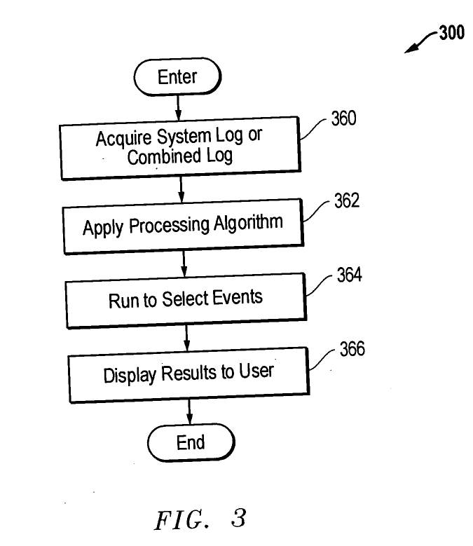

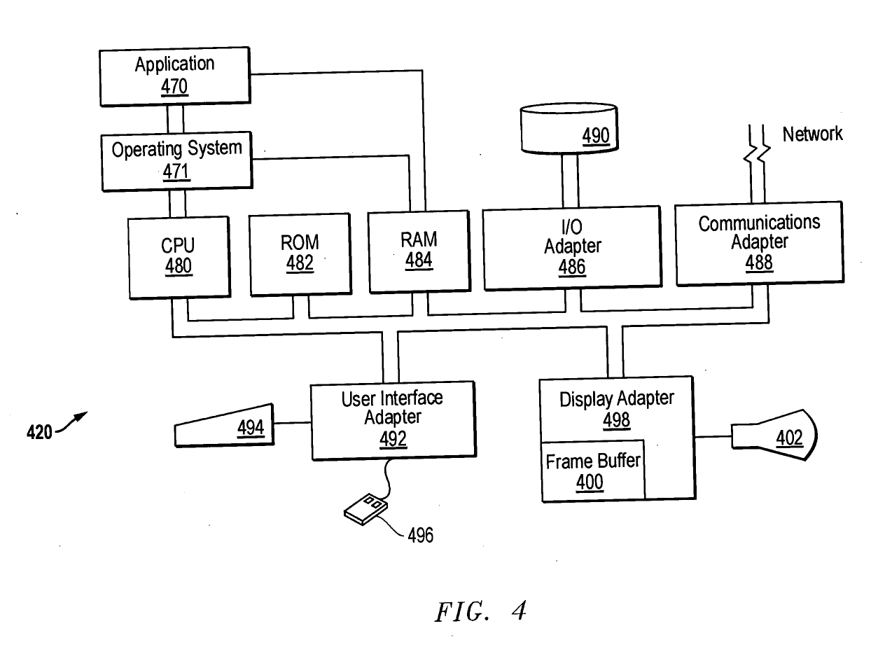

Example embodiments for the present invention will now be described with respect to the drawings. FIG. 1 is an example block diagram for a centralized audit log manager system according to the present invention. FIG. 2 is an example flow diagram for retrieving event logs from numerous systems. FIG. 3 is an example flow diagram for analyzing the centralized event log. And FIG. 4 is an example block diagram for a system that can store event logs.

Looking now to FIG. 1, a block diagram is shown of a system 100 according to the present invention for the acquisition and centralized storage of event logs from multiple disparate systems. Multiple systems and their event logs are shown. In particular, System A 112 has an event log 114. System B 116 has an event log 118. And System C 120 has an event log 122. These systems each could represent testing equipment, computer systems, or any other such system within a computer or electronic laboratory within a facility or one or more facilities. Preferably, these systems will have a wired or wireless network connection that can communicate with a network 102. This network 102 can be a wide variety of wired or wireless connections that together provide network communications. In addition, as depicted, the system 100 includes a CALM server 128 and a centralized database 130 for storing event log and user information data. Still further, the system 100 can be located within a secure facility.

As discussed above, where systems 112, 116 and 118 are disparate systems, the event logs 114, 118 and 122 will likely contain different information and be formatted in different manners. In addition, the amount of data stored in these files could be extremely large. The event logs 114, 118, and 122 are accessed through the network 102 by the server 128. For example, these event log files can be retrieved by utilizing a user-defined collection schedule that retrieves event log files, for example, hourly or daily or weekly. A selective determination of events from each log is made by an event selection routine 124 in the server 128. Selected events are correlated into the event format of the centralized event log 132 within the centralized database 130. The event logs are stored in the event log 132 through an event correlation routine 126 within the server 128 to provide a uniform chronological centralized event log 132. The centralized event log 132, for example, can be a security event log, and the events can be selected based on security needs. The centralized event log can also be maintained in a location inaccessible to general users, if desired. It is noted that the format of the centralized event log 132 can also be structured, as desired. As indicated above, one example structure is to identify events by system chronologically and to store data for a predetermined set of events. It is noted, however, that the centralized event log 132 could be organized in any desired manner depending upon the particular needs of the implementation. It is also noted that other system variations could be made without departing from the centralized event log acquisition and storage of the present invention.

FIG. 2 shows a flowchart of one embodiment 200 for the present invention for acquisition of events or information for the centralized event log for the system 100, for example, beginning with the event log of System A 112. Once the event log 114 for System A 112 has been processed, the next event log may be selected and processed, such as event log 118 for System B 116. This event log is processed in the same manner. This process can continue until all event logs are processed

More particularly, as depicted in FIG. 2, a first system event log is accessed in process step 240. The system event log and/or events from the event log are selected for storage in the centralized event log in process step 242. In process step 244, selected events are correlated to centralized event log format and then stored in the centralized event log in process step 246. As indicated above, wired or wireless networks can be used to connect to systems, access event logs, and store to centralized database. And these networks can also be made to be secure networks that are used solely for event log auditing purposes and/or for other purposes. Still further, a software module may be run on each system along with a central software module on a secure server to allow secure access and retrieval of event logs. It is further noted that in one embodiment, archiving of such event data to an optical storage device for long-term storage is performed.

In process step 248, a determination is made regarding whether processing of all event logs is complete. If “Yes,” then the process ends. If “No,” step 250 is reached where the process is passed on for selection of the next event log. The process 200 then repeats with the next event log. Thus, according to the present invention, data fusion of the disparate event logs can be accomplished by combining event log data from the different systems, which store different types of data in different data formats, into a common format that is easily analyzed by processing algorithms and/or interpreted by the person responsible for examining or auditing event log information.

FIG. 3 shows a flowchart of an embodiment 300 for an analysis of events for the centralized event log for the system 100. In this embodiment 300, each individual event log is analyzed to identify activities selected for review by the algorithm being implemented. In process step 360, an event log of a selected database is acquired or accessed within the centralized database, such as the centralized data stored for event log 114 from System A 112. Alternatively, a combined log can be accessed that combines two or more individual system logs. In process step 362, a desired processing algorithm is applied to the event log. It is noted that a plurality of algorithms could be created and that one or more could be run in an automated fashion. In addition, a processing algorithm could be manually selected by a user to be run on the log data. Next, in process step 364, events identified through the processing algorithm are selected, and in step 366, the results of the processing algorithm are displayed to the user for review and action as needed depending upon the activities identified. In addition, if automated processing algorithms are implemented, automated notifications could be provided for notifying a user through an electronic communication that an event has been identified meeting the criteria of the processing algorithm. For example, an ISSO could be notified by a page any time the event log data is analyzed, and it is determined that repeated log-in failures have occurred on a single system or across multiple systems in a short period of time. Again, as noted above, the event logs can also be analyzed in any combinations or logical configuration as desired to achieve the detection goals for the system being implemented while still taking advantage of the centralized storage of disparate event log data according to the present invention. Furthermore, if desired, the centralized event log is then monitored on a real time basis to detect sets of events triggering security alerts.

As stated above, the processing algorithms can be configured to look for any desired pattern or event within the centrally stored system usage data. One example for an algorithm analysis that could be used with the invention is the display and analysis of all events on a particular date during a period of time in which system usage is not expected. For example, log-ins or application usage during late night or early morning hours when no one is supposed to be working or using the systems. A second example of an algorithm analysis that could be used with this invention is the analysis of all login failures where two or more failures have occurred within 5 minutes of each other on the same machine or on different closely positioned machines. Such events could be indicative of an unauthorized person attempting to log-in to a number of systems. A third example of an analysis algorithm for the present invention is the analysis of activities over time and across different systems. In addition, as indicated above, graphical depictions of data analysis results can be provided to users for easy understanding, review and interpretation by an event log interpreter (such as an ISSO).

Referring to FIG. 4, an example data processing system 420 used within a facility that may be configured to acquire and store event logs in a centralized database. A central processing unit (CPU) 480 provides processing power for the system 420 and may be any of a wide variety of the commercial microprocessors in personal computers or other systems. The CPU 480 is interconnected to various other components by a system bus. An operating system 471 runs on a CPU 480, provides control and is used to coordinate the functions of the various components of FIG. 4. Operating system 471 may be one of the commercially available operating systems such as IBM's AIX 5L™ operating system, Microsoft's Windows XP™, or Windows2000™, as well as other UNIX and AIX operating systems.

Application programs 470, controlled by the system, are moved into and out of the main memory Random Access Memory (RAM) 484. These programs include the programs of the present invention for creating a centralized event log correlating the event logs of diverse databases. A Read Only Memory (ROM) 482 is connected to CPU 480 through the system bus and includes the Basic Input/Output System (BIOS) that controls the basic computer functions. RAM 484, input/output (I/O) adapter 486 and communications adapter 488 are also interconnected to the system bus. I/O adapter 486 communicates with the disk storage device 490. Communications adapter 488 interconnects bus with an outside network enabling the computer system to communicate with other systems and computers through network communications.

I/O devices are also connected to the system bus through user interface adapter 492 and display adapter 498. Keyboard 494 and mouse 496 are all interconnected to the system bus through user interface adapter 492. Display adapter 498 may include an optional frame buffer 400, which is a storage device that holds a representation of each pixel on the display screen 402. Images may be stored in frame buffer 400 for display on monitor 402 through various components, such as a digital to analog converter (not shown) and the like. By using the aforementioned I/O devices, a user is capable of inputting information to the system through the keyboard 494 or mouse 496 and receiving output information from the system via display 402.

Further modifications and alternative embodiments of this invention will be apparent to those skilled in the art in view of this description. It will be recognized, therefore, that the present invention is not limited by these example arrangements. Accordingly, this description is to be construed as illustrative only and is for the purpose of teaching those skilled in the art the manner of carrying out the invention. It is to be understood that the forms of the invention herein shown and described are to be taken as the presently preferred embodiments. Various changes may be made in the implementations and architectures. For example, equivalent elements may be substituted for those illustrated and described herein, and certain features of the invention may be utilized independently of the use of other features, all as would be apparent to one skilled in the art after having the benefit of this description of the invention.

What is claimed is:

1. A method for analyzing event logs from a plurality of different systems, comprising:
accessing an event log from each of a plurality of different systems, the event logs being configured to store data in two or more different formats;
storing selected event data from each event log in a common format within a centralized event log within a centralized database; and
analyzing the stored event data within the centralized database to identify events meeting one or more predetermined parameters.

2. The method of claim 1, wherein the storing step comprises storing the selected event data from the different event logs in a chronological format.

3. The method of claim 1, wherein the centralized event log is a security event log and the parameters are selected based on security needs.

4. The method of claim 1, further comprising monitoring the centralized event log on real time basis to detect events triggering security alerts.

5. The method of claim 1, wherein the plurality of different systems comprise computer systems.

6. The method of claim 1, wherein said accessing step comprises accessing of the event logs through a network connection.

7. The method of claim 1, wherein the analyzing step comprises running an automated processing algorithm on the stored event data.

8. The method of claim 7, further comprising running an algorithm that analyzes events across multiple systems.

9. The method of claim 1, wherein the accessing and storing steps are conducted on a periodic basis.

10. The method of claim 9, wherein the analyzing step is conducted manually.

11. The method of claim 1, further comprising displaying result information graphically.

12. A centralized log manager system for analyzing event logs from a plurality of different systems, comprising:
a plurality of different systems configured to store usage information in an event log, the event logs being configured to store data in two or more different formats;
a server system configured to communicate with the plurality of different systems to obtain event data from the event logs and to store selected event data from each event log in a common format in a centralized event log within a centralized database;
wherein the server system is further configured to analyze the stored event data within the centralized database to identify events meeting one or more predetermined parameters.

13. The system of claim 12, wherein the selected event data from the different event logs is stored in a chronological format.

14. The system of claim 12, wherein the centralized event log is a security event log and the parameters are selected based on security needs.

15. The system of claim 12, wherein the server system is further configured to monitor the centralized event log on real time basis to detect events triggering security alerts.

16. The system of claim 12, wherein the plurality of different systems and the server system are coupled through a network connection.

17. The system of claim 12, wherein the server system is further configured to run an automated processing algorithm on the stored event data.

18. The system of claim 17, wherein the automated processing algorithm is configured to analyze events across multiple systems.

19. The system of claim 12, wherein the server system is further configured to access the event logs on a periodic basis.

20. The method of claim 12, wherein the server system is further configured to provide a graphical depiction of event data through a display.
